(19) United States
(12) Patent Application Publication
(10) Pub. No.: US 2018/0127086 A1
(43) Pub. Date: May 10, 2018

(54) Aerial Vehicle and Propeller Thereof

(71) Applicant: Coretronic Intelligent Robotics Corporation, HSINCHU COUNTY (TW)

(72) Inventors: YING-CHIEH CHEN, Hsin-Chu (TW); SHIH-HANG LIN, Hsin-Chu (TW); PEI-RONG WU, Hsin-Chu (TW)

(21) Appl. No.: 15/807,461

(22) Filed: Nov. 8, 2017

(30) Foreign Application Priority Data
Nov. 10, 2016 (CN) 201621211109.0

(51) Int. Cl. B64C 11/18

(52) U.S. Cl. CPC B64C 11/18; B64C 39/024

(57) ABSTRACT

An aerial vehicle and a propeller thereof are provided. The propeller includes a hub and at least one blade. The hub is rotatable about a shaft, and the blade is mounted to the hub. The blade extends from the hub to a tip along a first direction and has a leading edge and a tailing edge opposite to the leading edge. The blade has a section along a second direction in an arbitrary position along the first direction. The second direction is perpendicular to the first direction. A section of the blade in a first position along the first direction has a first peak value of chord length, and a section of the blade in a second position along the first direction has a second peak value of chord length. The second position is between the first position and the tip.

### FIELD OF THE INVENTION

The invention relates to an aerial vehicle and a propeller thereof, and more particularly to an aerial vehicle and a propeller having a lower pitch angle and shorter chord length in a low lift region and a higher pitch angle and a longer chord length in a main lift region.

### BACKGROUND OF THE INVENTION

Referring to FIGS. 1 and 2, a conventional propeller is shown. A conventional propeller 100 includes a hub 10 and two blades 20 connected to the hub 10. The blades 20 have a shape shown in FIG. 2. For design concepts of a propeller, a blade shape of each propeller can be considered as a combination of infinite sections. Since typical design methods of propeller cannot ensure to obtain an optimal design, the design method of blade shape nowadays is to divide a blade into several segments along a span direction of the blade, afterwards a shape of each segment is designed separately, and finally all segments are combined to become a complete blade.

FIG. 3 shows a section of the blade 20 of the propeller 100. The blade 20 has a leading edge 22 and a tailing edge 24. A line connecting the leading edge and the tailing edge is defined as a chord line C. The length of the chord line C is the chord length. An angle between the chord line C and a rotational plane R of the propeller 100 is defined as a pitch angle A (also refer to blade pitch or blade angle). A surface connecting the leading edge 22 and the tailing edge 24 above the chord line C is defined as a blade back 26, and a surface connecting the leading edge 22 and the tailing edge 24 under the chord line C is defined as a blade face 28. The blade back 26 has larger curvature than the blade face 28, and thus the air flow along the blade back 26 has a larger speed than the air flow along the blade face 28. Bernoulli's principle states that an increase in the speed of air flow occurs simultaneously with a decrease in pressure, or a decrease in the speed of air flow occurs simultaneously with an increase in pressure. A high pressure region is formed on the blade face 28 due to air flow of low speed, and the pressure exerted on the blade face 28 is larger than the pressure exerted on the blade back 26. The difference of the pressure on the blade face 28 and the blade back 26 generates lift.

Table 1 shows chord length and pitch angle in different positions of a blade shape of a commercial propeller, T-motor 18×6.1, and the blade shape is shown in FIG. 2.

TABLE 1

| | distance | | | |
|---|---|---|---|---|
| diameter | (mm)from | | | |
| (mm), the | different | | | |
| total length | positions in | ratio of the | pitch | chord |
| of the | the blades | distance | angle | length |
| propeller | to the hub | to a radius | (degree) | (mm) |
| 457.2 | 50 | 0.22 | 22.5 | 36 |
| | 85 | 0.37 | 16.7 | 45 |
| | 125 | 0.55 | 11.8 | 40 |
| | 165 | 0.72 | 9.6 | 32.6 |
| | 220 | 0.96 | 7.1 | 17.3 |

The specification of a blade shape of the commercial propeller is shown in table 1, wherein the diameter means the total length of the propeller 100, and the radius means a distance from a center of the hub to a tip of the blade 20. The commercial propeller has an excessively high pitch angle or overlong chord length in a low lift region where the ratio of the distance to the radius ranges from 20% to 37% to cause increase of wind drag and motor power loss and thus have a poor efficiency. The region of the high pressure overlaps only a part of the high lift region where the ratio of the distance to the radius ranges from 70% to 100%, and therefore a lower lift is generated.

The information disclosed in the “BACKGROUND OF THE INVENTION” section is only for enhancement understanding of the background of the invention and therefore it may contain information that does not form the prior art that is already known to a person of ordinary skill in the art. Furthermore, the information disclosed in the “BACKGROUND OF THE INVENTION” section does not mean that one or more problems to be solved by one or more embodiments of the invention were acknowledged by a person of ordinary skill in the art.

### SUMMARY OF THE INVENTION

The invention provides a propeller having a high pressure difference region concentrated on a main lift region through increasing or regulating chord length or pitch angle of a part of blade shape, and thus the lift and efficiency of the propeller of the invention is increased and the thrust efficiency of the propeller is also improved.

Other objects and advantages of the invention can be understood through the disclosed technical features of the invention.

In order to achieve one or a portion or all of the objects or other objects, the invention provides an embodiment of a propeller including a hub rotatable with respect to a shaft and at least one blade connected to the hub and extending from the hub to a tip of the at least one blade along a first direction, wherein the blade comprises a leading edge extending along the first direction and a tailing edge opposite to the leading edge, a plurality of sections are defined along a second direction perpendicular to the first direction in a plurality of positions of the blade, the positions comprise a first position and at least one second position located between the first section and the tip, the sections comprise a first section corresponding to the first position and a second section corresponding to the second position, the first section has a first peak value of chord length and the second section has a second peak value of chord length.

The invention also provides an aerial vehicle provided with a propeller of the invention. The aerial vehicle of the invention has higher fly speed and lower power loss of the motor (engine) through the propeller of the invention which has a lower wind drag and larger lift.

In order to achieve one or a portion or all of the objects of the invention, the invention provides an aerial vehicle including a body and a propeller mounted to the body.

The propeller of the invention has a high pressure difference region concentrated on a main lift region through increasing or regulating chord length or pitch angle of a part of blade shape, and thus the lift and efficiency of the propeller of the invention is increased.

Other objectives, features and advantages of the invention will be further understood from the further technological features disclosed by the embodiments of the invention wherein there are shown and described preferred embodiments of the invention, simply by way of illustration of modes best suited to carry out the invention.

### BRIEF DESCRIPTION OF THE DRAWINGS

The accompanying drawings are included to provide a further understanding of the invention, and are incorporated in and constitute a part of the specification. The drawings illustrate embodiments of the invention and, together with the description, serve to explain the principles of the invention.

FIG. 1 is a schematic view of a conventional propeller;

FIG. 2 is a schematic view of a blade of the conventional propeller of FIG. 1;

FIG. 3 depicts a section of the blade of FIG. 2;

FIG. 4 is a curve diagram of rotational speed versus thrust obtained by computer simulation and actual measurement for blades of two conventional propeller;

FIG. 5 is a curve diagram of thrust versus ratio of thrust to power obtained by computer simulation and actual measurement for blades of two conventional propellers;

FIG. 6 is a front view of a propeller of the invention;

FIG. 7 is a side view of the propeller of FIG. 6;

FIG. 8 is a schematic view of a blade of the propeller of FIG. 6;

FIG. 9 depicts a high pressure region of a propeller of the invention versus a high pressure region of a conventional propeller;

FIG. 10 is a curve diagram of thrust versus ratio of thrust to power obtained by computer simulation and actual measurement for a propeller of the invention and a conventional propeller; and

FIG. 11 is a perspective view of an aerial vehicle of the invention.

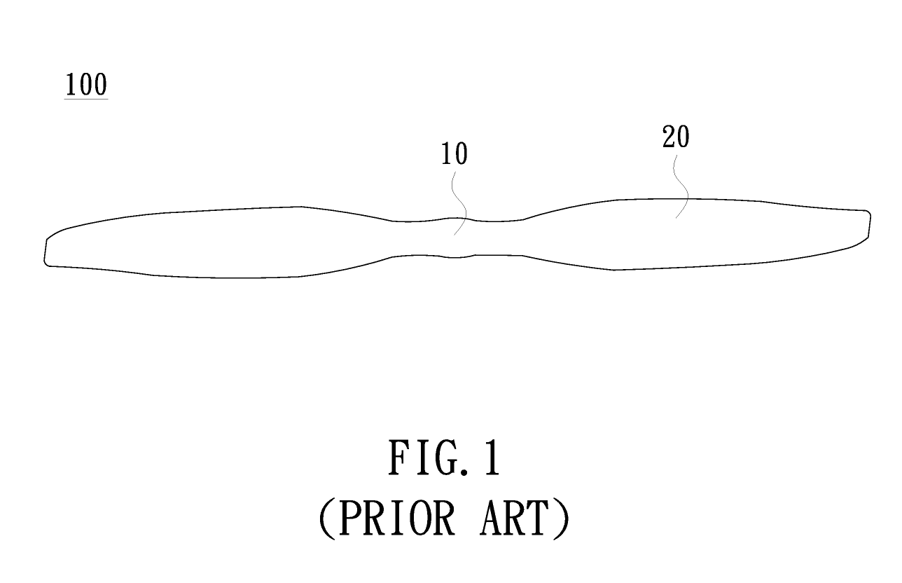

### DETAILED DESCRIPTION OF PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top”, “bottom”, “front”, “back”, etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing”, “faces”, and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

A blade shape of a propeller of the invention is designed by software, and the design focuses on the high pressure distribution in a main lift region and the wind drag loss in a low lift region. However, it is to be identified first that the error between the data of computer simulation and actual measurement for the physical parameters of the propeller is acceptable.

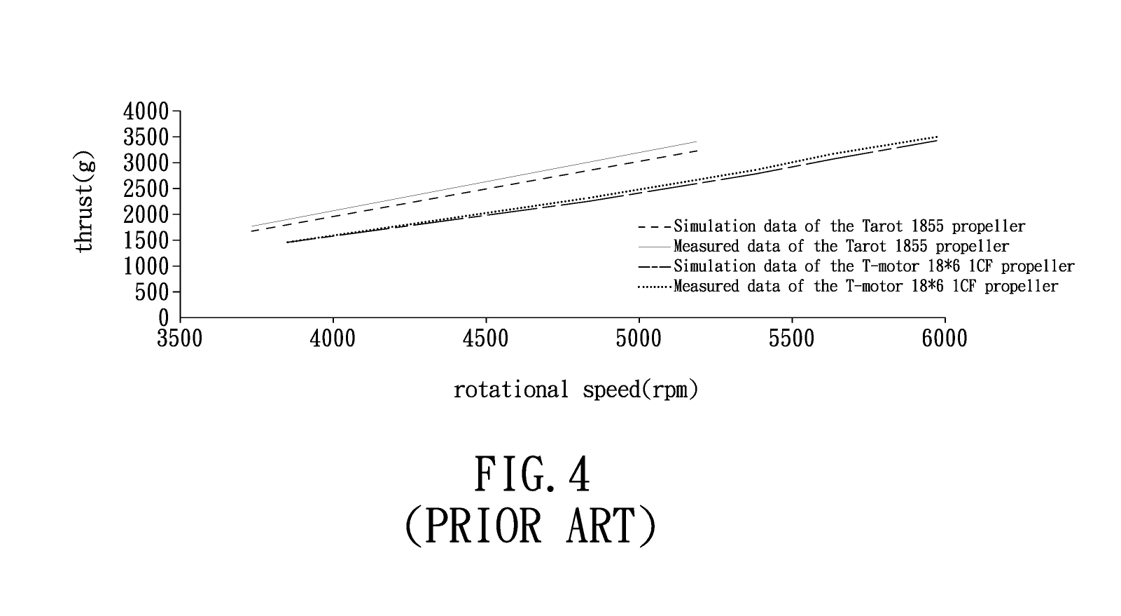

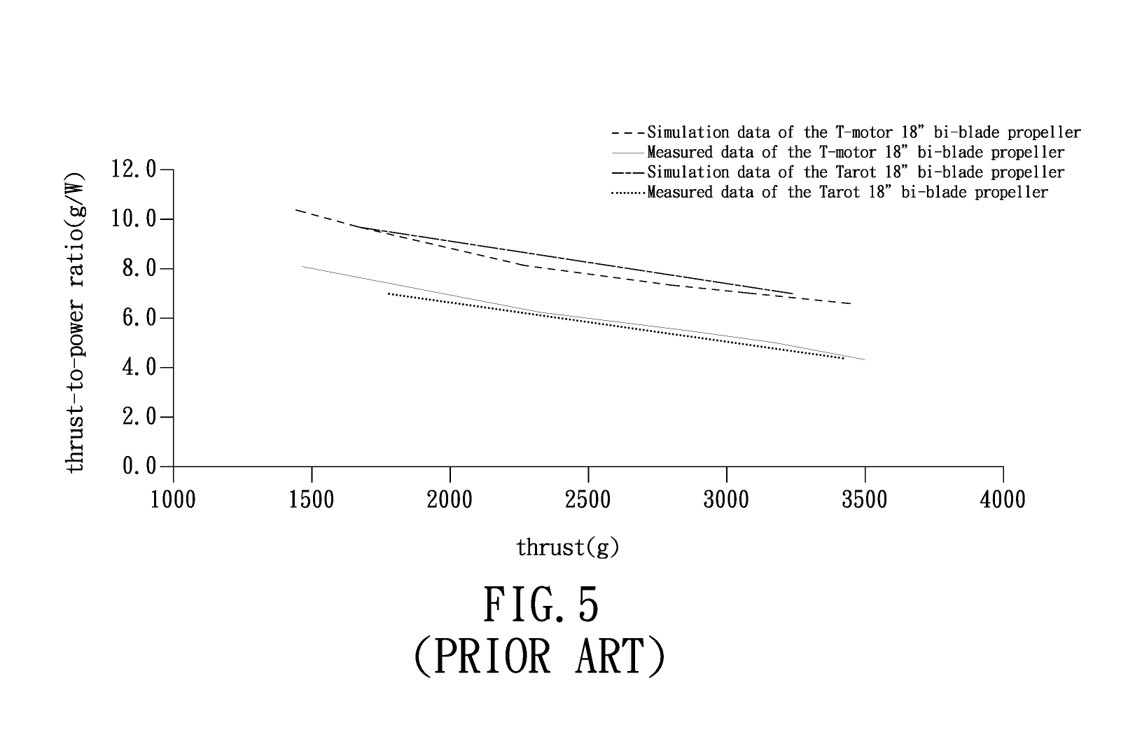

Referring to table 2, table 3, FIG. 4 and FIG. 5, table 2 shows data obtained by computer simulation and actual measurement for rotational speed and thrust of two commercial propellers (Tarot 1855 and T-Motor 18×6.1), FIG. 4 is a curve diagram of the rotational speed and the thrust of two commercial propellers (Tarot 1855 and T-Motor 18×6.1) based on the data of table 2, table 3 shows data of computer simulation and actual measurement for the thrust and the ratio of thrust to power of two commercial propellers (Tarot 1855 and T-Motor 18×6.1), and FIG. 5 is a curve diagram of the thrust and the ratio of thrust to power of the commercial propellers (Tarot 1855 and T-Motor 18×6.1) based on the data of table 3.

TABLE 2

| | Rotational | Thrust(g) | Thrust(g) | Error of |
|---|---|---|---|---|
| | speed | (actual | (computer | thrust |
| propeller | (rpm) | measurement) | simulation) | (%) |
| Tarot 1855 | 3734 | 1778 | 1673 | 5.9% |
| | 5187 | 3418 | 3235 | 5.4% |
| T-Motor | 3850 | 1463 | 1442 | 1.4% |
| 18 × 6.1CF | 4836 | 2323 | 2266 | 2.5% |
| electrical | 5376 | 2858 | 2794 | 2.2% |
| converter | 5630 | 3168 | 3072 | 3.0% |
| (40A) | 5970 | 3498 | 3441 | 1.6% |

TABLE 3

| | | | | | | | | Moto | |
|---|---|---|---|---|---|---|---|---|---|
| | | | | | | | | power of | |
| | | | | | | | | a | |
| | | | | | | | Ratio of | bi-blade | Ratio of |
| | | | | | | | thrust to | propeller | thrust to |
| | | | | | | Error | power | obtained | power |
| | | Motor | Rotational | Thrust | Thrust (g) | of | (g/W) | by | (g/W) |
| | Throttle | power | speed | (g) (actual | (computer | thrust | (actual | Simulation | (computer |
| propeller | (%) | (Watt) | (rpm) | measurement) | simulation) | (%) | measurement) | (W) | simulation) |
| Tarot | 50% | 255 | 3734 | 1778 | 1673 | 5.9% | 7.0 | 173.5 | 9.6 |
| 1855 | 70% | 786 | 5187 | 3418 | 3235 | 5.4% | 4.3 | 464.8 | 7.0 |
| T-Motor | 50% | 182 | 3850 | 1463 | 1442 | 1.4% | 8.0 | 139.5 | 10.3 |
| 18 × 6.1CF | 65% | 373 | 4836 | 2323 | 2266 | 2.5% | 6.2 | 278.4 | 8.1 |
| | 75% | 521 | 5376 | 2858 | 2794 | 2.2% | 5.5 | 381 | 7.3 |
| | 85% | 633 | 5630 | 3168 | 3072 | 3.0% | 5.0 | 439.3 | 7.0 |
| | 100% | 815 | 5970 | 3498 | 3441 | 1.6% | 4.3 | 523.3 | 6.6 |

According to the data of table 2, the thrust has about 5% error between the computer simulation value and the actual measurement value. According to the data of table 3, the ratio of thrust to power has about 10% error between the computer simulation value and the actual measurement value. Therefore, it is shown that the error between the computer simulation value and the actual measurement value is acceptable according to the data of thrust and ratio of thrust to power obtained by computer simulation and the actual measurement. Therefore, the computer simulation is indeed a feasible design method.

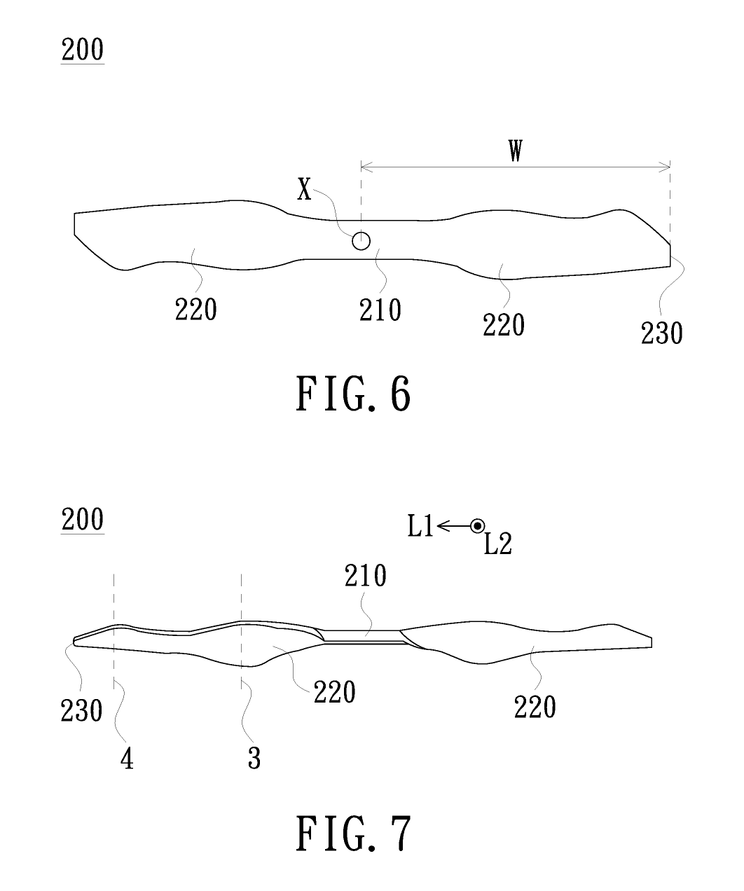

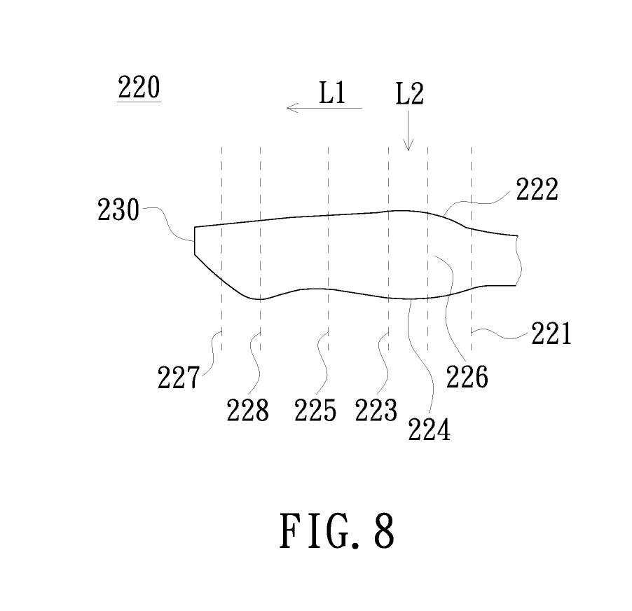

Referring to FIGS. 6, 7 and 8, an embodiment of a propeller of the invention is shown. FIG. 6 is a front view of a propeller of the invention. FIG. 7 is a side view of the propeller of FIG. 6. FIG. 8 is a blade of the propeller of FIG. 6. A propeller 200 of the invention includes a hub 210 and two blades 220. The hub 210 is rotatable with respect to a shaft X which is mounted to a center of the hub 210. The shaft X is also mounted to a substantial center (not shown) of a rotational motor. The rotational motor rotates the hub 210 so as to rotate the blades 220. The blades 220 are connected to the hub 210 and aligned with each other. The blades 220 are symmetrical with respect to the hub 210. The blade 220 extends from the hub 210 to a tip 230 along a first direction L1 and includes a leading edge 222 along the first direction L1 and a tailing edge 224 opposite to the leading edge 222. The blade 220 includes a plurality of sections along a second direction L2 in a plurality of positions along the first direction L1, a line connecting the leading edge 222 and the tailing edge 224 is defined as a chord line, and a distance between the leading edge 222 and the tailing edge 224 is defined as a chord length. An angle between the chord line and a rotational plane of the propeller 200 is defined as a pitch angle. A distance between the hub 210 to the tip 230 is defined as a span length W. The definitions of the chord line, the chord length and the pitch angle are referred to FIG. 3. The second direction L2 is perpendicular to the first direction L1. The positions include a first position 226 and a second position 228. The section of the first position 226 has a first peak value of chord length, and the section of the second position 228 has a second peak value of chord length. The second position 228 is between the first position 226 and the tip 230.

Although a bi-blade propeller is described as an example in the embodiment, however the invention is not limited thereto. The number of the blades 220 can be one, three or other numbers. In addition, in another embodiment, the number of the hub 210 can be even (not shown) and the hubs are connected to the blades 220 and connected to a rotational motor to rotate the blades 220.

In the embodiment, although the blade 220 has a first peak value of chord length in the first position 226 and a second peak value in the second position 228 respectively along the first direction, the invention is not limited thereto. In addition to the second position 228, the blade 220 may include other peak values of chord length in other position between the first position 226 and the tip 230 according to requirements. In the embodiment, the leading edge 222 and the tailing edge 224 are wavy. The leading edge 222 has a wave peak in the first position 226, and the tailing edge has two wave peaks in the first position 226 and the second position 228. In the embodiment, the first peak value of chord length in the first position 226 is the maximal value of chord length along the first direction.

In the embodiment, the first position 226 is located in a position ranging from 22% to 55% of the span length from the hub 210, and the second position 228 is located in a position ranging from 70% to 100% of the span length from the hub 210.

In the embodiment, referring to FIG. 7, the blade 220 has a first peak value of pitch angle in a third position 3 along the first direction L1, and a second peak value of pitch angle in a fourth position 4 along the first direction L1. The fourth position 4 is between the third position 3 and the tip 230. When the blade 220 is viewed from its lateral side, the pitch angles in the third position 3 and the fourth position 4 are larger than the pitch angles in positions adjacent to the third position 3 and the fourth position 4. Referring to FIGS. 7 and 8, in the embodiment, the third position 3 coincides with the first position 226, and the fourth position 4 coincides with the second position 228. However, the invention is not limited hereto, in another embodiment, the third position 3 is a position other than the first position 226, and the fourth position 4 is a position other than the second position 228. In the embodiment, the first peak vale of pitch angle in the third position 3 is the maximal value of pitch angle along the first direction L1.

Referring to FIG. 8, the blade 220 of the propeller 200 is divided into seven segments in the embodiment. A section is defined between two adjacent segments, and therefore six sections are defined by seven segments. The six sections include a first section, a second section, a third section, a fourth section, a fifth section and a sixth section, but the invention is not limited thereto. The first section is in a fifth position 221 and distanced from the hub 210 by 50 mm. The first section has a chord length of 27.9 mm, a pitch angle ranging from 14 to 18 degree and a thickness of 3.5 mm. Preferably, the first section has a pitch angle of 15.7 degree. The second section is in the first position 226 (in the embodiment, the third position 3 coincides with the first position 226) and distanced from the hub 210 by 85 mm. The second section has a chord length of 42.8 mm, a pitch angle ranging from 18-22 degree and a thickness of 3.5 mm. Preferably, the second section has a pitch angle of 20 degree. The third section is in a sixth position 223 and distanced from the hub 210 by 125 mm. The third section has a chord length of 40.5 mm, a pitch angle ranging from 11-15 degree and a thickness of 2 mm. Preferably, the third section has a pitch angle of 12.7 degree. The fourth section is in a seventh position 225 and distanced from the hub 210 by 165 mm. The fourth section has a chord length 35.9 mm, a pitch angle of 10 degree and a thickness of 2 mm. The fifth section is in the second position 228 (in the embodiment, the fourth position 4 coincides with the second position 228) and distanced from the hub 210 by 195 mm. The fifth section has a chord length of 38 mm, a pitch angle ranging from 9-13 degree and a thickness of 2 mm. Preferably, the fifth section has a pitch angle of 10.6 degree. The sixth section is in an eighth position 227 and distanced from the hub 210 by 220 mm. The sixth section has a chord length of 20.7 mm, a pitch angle of 10 degree and a thickness of 1.5 mm.

Table 4 shows the pitch angle and chord length in different positions of the propeller 200 of the invention.

TABLE 4

| Diameter | | | | | |
|---|---|---|---|---|---|
| (mm) | | | | | |
| (total | | | | | |
| length | | distance | ratio of the | pitch | chord |
| of the | | from the | distance | angle | length |
| propeller) | section | hub(mm) | to the radius | (degree) | (mm) |
| 457.2 | first | 50 | 0.22 | 15.7 | 27.9 |
| | section | | | | |
| | second | 85 | 0.37 | 20 | 42.8 |
| | section | | | | |
| | third | 125 | 0.55 | 12.7 | 40.5 |
| | section | | | | |
| | fourth | 165 | 0.72 | 10 | 35.9 |
| | section | | | | |
| | fifth | 195 | 0.85 | 10.6 | 38 |
| | section | | | | |
| | sixth | 220 | 0.96 | 10 | 20.7 |
| | section | | | | |

Comparing the table 4 with the table 1, the blade 220 of the propeller 200 of the invention has a longer chord length and a larger pitch angle in the fourth section, the fifth section and the sixth section, which are located in the main lift region than a commercial propeller. For example, the fifth section has a second peak value of chord length and a second peak value of pitch angle. This enables the high pressure region of air flow to concentrate on the main lift region to increase lift of the propeller.

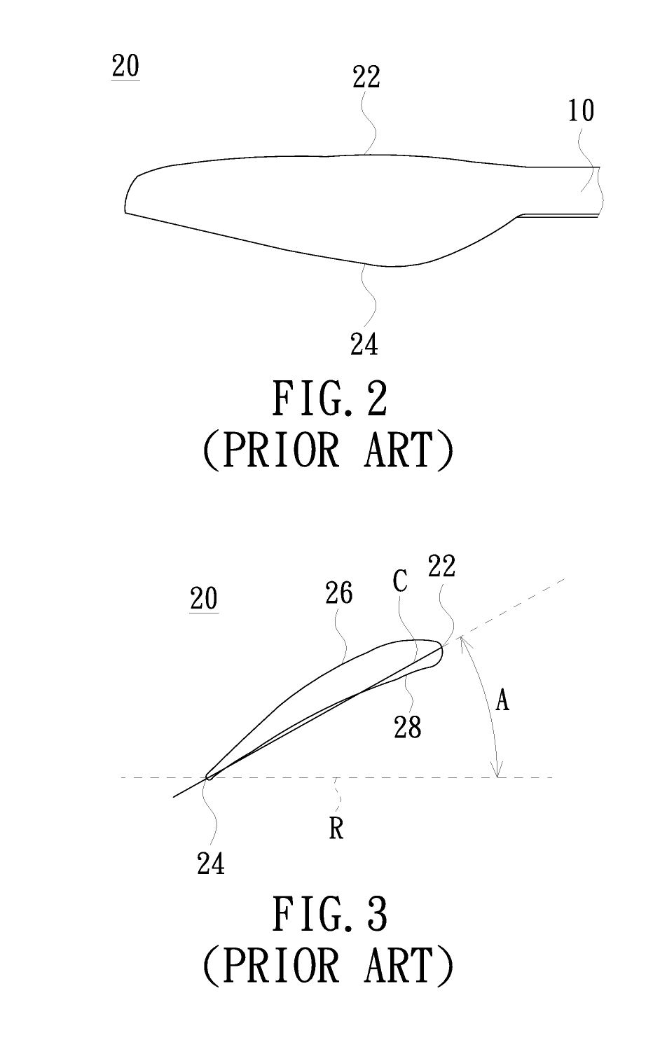

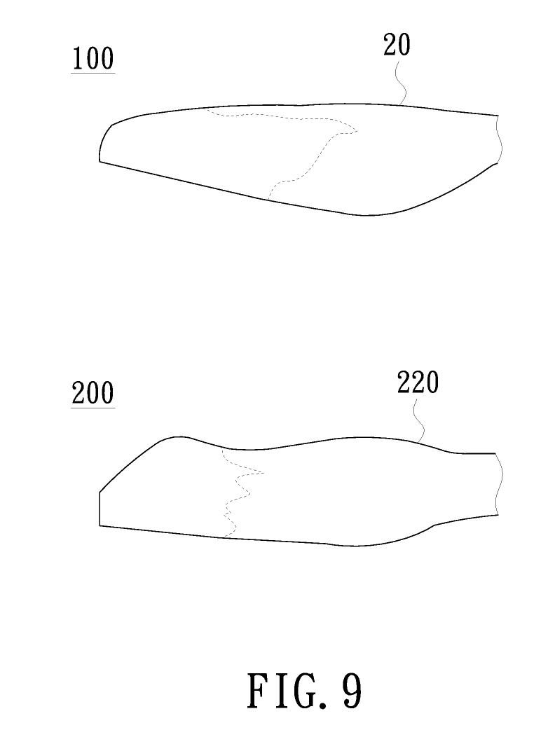

FIG. 9 shows the high pressure region of the blade 220 of the propeller 200 of the invention and the high pressure region of the blade 20 of the conventional propeller 100. The high pressure region of the blade 220 of the invention (the region shown by the dashed line of FIG. 9) concentrates on a region containing the fourth section to the sixth section (the ratio of the distance to the radius ranging from 0.72-0.96) (referring to FIG. 8 and table 4). That is the high pressure region of the blade 220 concentrates on the main lift region (where the ratio of the distance to the radius ranging from 0.7-1.0). However the high pressure region of the blade 20 of the conventional propeller 100 concentrates on the region where the ratio of the distance to the radius ranges from 0.55 to 0.96 (referring to FIG. 2 and table 1). That is only a part of the high pressure region overlaps the main lift region. Therefore, the high pressure region of the blade 220 of the invention concentrates on the main lift region.

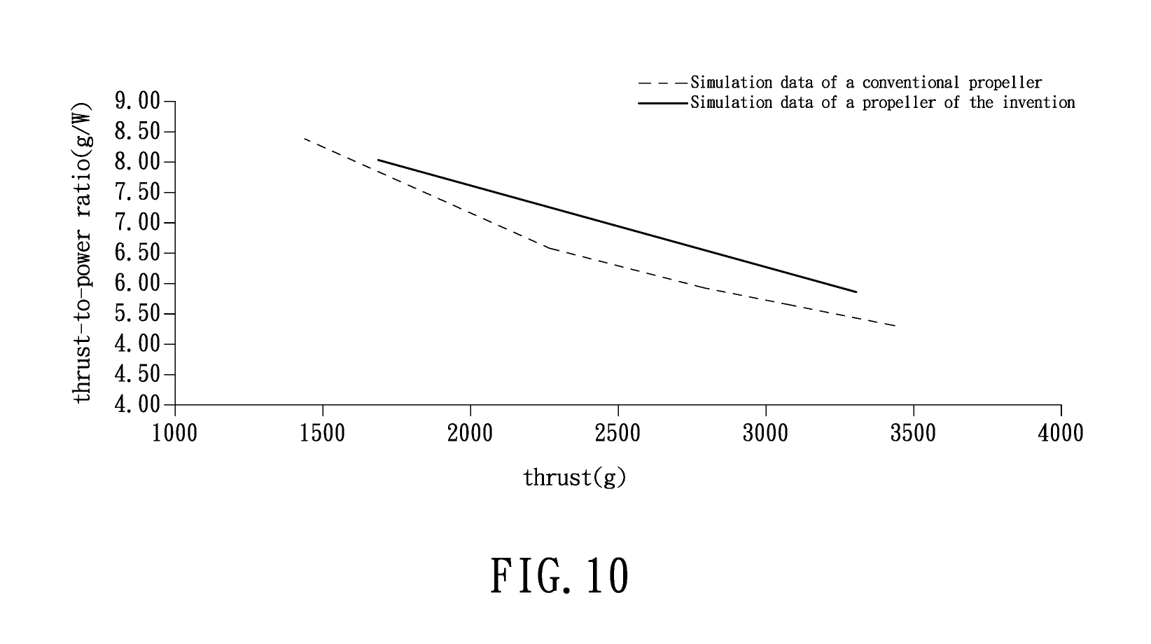

FIG. 10 is a curve diagram of thrust versus ratio of thrust to power obtained by computer simulation and actual measurement for the propeller 200 of the invention and a conventional propeller 100. For the thrust 3000 g, the propeller 200 of the invention has ratio of thrust to power 10% more than the ratio of thrust to power of the conventional propeller 100. Therefore, the propeller 200 has a better ratio of thrust to power than the conventional propeller 100 in generating the same thrust.

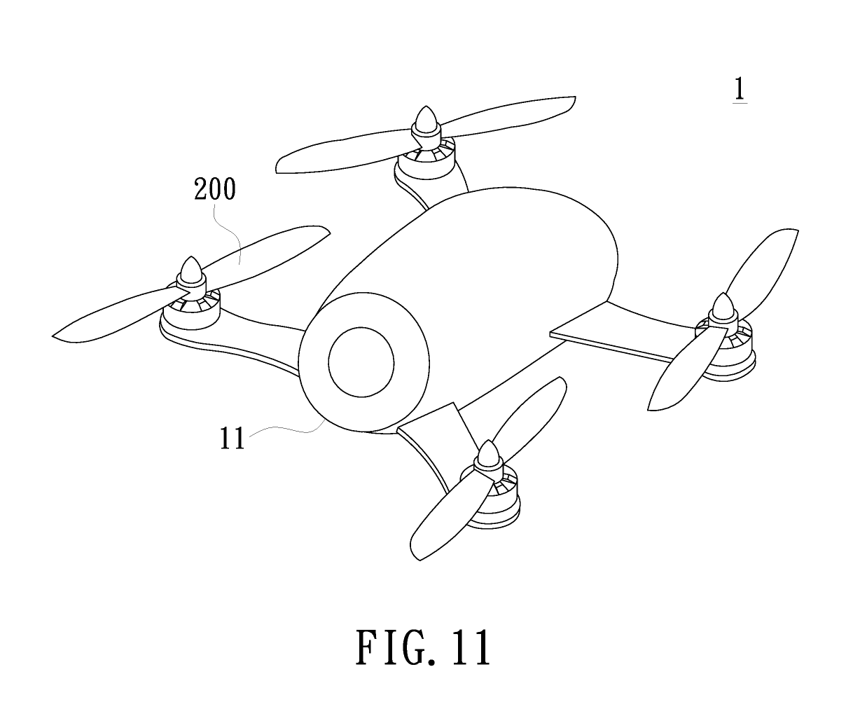

FIG. 11 is a perspective view of an aerial vehicle of the invention. The propeller 200 can be mounted to a body 11 of an aerial vehicle 1, such as an unmanned aerial vehicle (UAV). Since the propeller 200 of the invention generates a larger lift and a lower wind drag so as to have lower power consumption, the aerial vehicle on which the propeller 200 of the invention is mounted has higher velocity, larger loading weight and longer cruising endurance than the aerial vehicle provided with the conventional propeller 100.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from the disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims. Furthermore, the terms such as the first stop part, the second stop part, the first ring part and the second ring part are only used for distinguishing various elements and do not limit the number of the elements.

What is claimed is:

1. A propeller, comprising:
a hub rotatable with respect to a shaft; and
at least one blade connected to the hub and extending from the hub to a tip of the at least one blade along a first direction, wherein the at least one blade comprises a leading edge extending along the first direction and a tailing edge opposite to the leading edge, a plurality of sections are defined along a second direction perpendicular to the first direction in a plurality of positions of the at least one blade, the plurality of positions comprise a first position and at least one second position located between the first section and the tip, the plurality of sections comprise a first section corresponding to the first position and a second section corresponding to the at least one second position, the first section has a first peak value of chord length and the second section has a second peak value of chord length.

2. The propeller according to claim 1, wherein a span length is defined as a distance from the hub to the tip, the first position is located in a position within a range from 22% to 55% of the span length from the hub, and the at least one second position is located in a position within a range from 70% to 55% of the span length from the hub.

3. The propeller according to claim 1, wherein the first peak value of chord length is the maximal value of chord length in all of the plurality of positions of the at least one blade along the first direction.

4. The propeller according to claim 1, wherein the plurality of positions further comprise a third position and at least one fourth position located between the third position and the hub, the plurality of sections further comprise a third section corresponding to the third position and a fourth section corresponding to the at least one fourth position, the third section has a first peak value of pitch angle, and the fourth section has a second peak value of pitch angle.

5. The propeller according to claim 4, wherein a span length is defined as a distance from the hub to the tip, the first position is located in a position within a range from 22% to 55% of the span length from the hub, and the at least one second position is located in a position within a range from 70% to 55% of the span length from the hub.

6. The propeller according to claim 4, wherein the first peak value of pitch angle is the maximal value of pitch angle in all of the plurality of positions of the at least one blade along the first direction.

7. The propeller according to claim 4, wherein a distance from the third position to the hub is 85 mm, and a distance from the at least one fourth position to the hub is 195 mm.

8. The propeller according to claim 4, wherein the third section has a chord length of 42.8 mm, a pitch angle of 18-22 degree and a thickness of 3.5 mm, and the fourth section has a chord length of 38 mm, a pitch angle of 9-13 degree and a thickness of 2 mm.

9. The propeller according to claim 8, wherein the plurality of positions further comprise a fifth position, a sixth position, a seventh position and an eighth position, the plurality of sections further comprise a fifth section corresponding to the fifth position, a sixth section corresponding to the sixth position, a seventh section corresponding to the seventh position and an eight section corresponding to the eighth position, the fifth section is distanced from the hub by 50 mm which is 22% of the span length and has a chord length of 27.9 mm, a pitch angle of 14-18 degree and a thickness of 3.5 mm, the sixth section is distanced from the hub by 125 mm which is 55% of the span length and has a chord length of 40.5 mm, a pitch angle of 11-15 degree and a thickness of 2 mm, the seventh section is distanced from the hub by 165 mm which is 85% of the span length and has a chord length of 35.9 mm, a pitch angle of 9-13 degree and a thickness of 2 mm, and the eighth section is distanced from the hub by 220 mm which is 96% of the span length and has a chord length of 20.7 mm, a pitch angle of 8-12 degree and a thickness of 1.5 mm.

10. The propeller according to claim 1, wherein the tailing edge has a wave shape, and the first position and the at least one second position are wave peaks of the wave shape.

11. An aerial vehicle, comprising:
a body; and
a propeller mounted to the body, wherein the propeller comprises:
a hub rotatable with respect to a shaft; and
at least one blade connected to the hub and extending from the hub to a tip along a first direction, wherein the at least one blade comprises a leading edge extending along the first direction and a tailing edge opposite to the leading edge, a plurality of sections are defined along a second direction perpendicular to the first direction in a plurality of positions of the at least one blade, the plurality of positions comprise a first position and at least one second position located between the first section and the tip, the plurality of sections comprise a first section corresponding to the first position and a second section corresponding to the at least one second position, the first section has a first peak value of chord length and the second section has a second peak value of chord length.

12. The aerial vehicle according to claim 11, wherein a span length is defined as a distance from the hub to the tip, the first position is located in a position within a range from 22% to 55% of the span length from the hub, and the at least one second position is located in a position within a range from 70% to 55% of the span length from the hub.

13. The aerial vehicle according to claim 11, wherein the first peak value of chord length is the maximal value of chord length in all of the plurality of positions of the at least one blade along the first direction.

14. The aerial vehicle according to claim 11, wherein the plurality of positions further comprise a third position and at least one fourth position located between the third position and the hub, the plurality of sections further comprise a third section corresponding to the third position and a fourth section corresponding to the at least one fourth position, the third section has a first peak value of pitch angle, and the fourth section has a second peak value of pitch angle.

15. The aerial vehicle according to claim 14, wherein a span length is defined as a distance from the hub to the tip, the first position is located in a position within a range from 22% to 55% of the span length from the hub, and the at least one second position is located in a position within a range from 70% to 55% of the span length from the hub.

16. The aerial vehicle according to claim 14, wherein the first peak value of pitch angle is the maximal value of pitch angle in all of the plurality of positions of the at least one blade along the first direction.

17. The aerial vehicle according to claim 14, wherein a distance from the third position to the hub is 85 mm, and a distance from the at least one fourth position to the hub is 195 mm.

18. The aerial vehicle according to claim 14, wherein the third section has a chord length of 42.8 mm, a pitch angle of 18-22 degree and a thickness of 3.5 mm, and the fourth section has a chord length of 38 mm, a pitch angle of 9-13 degree and a thickness of 2 mm.

19. The aerial vehicle according to claim 18, wherein the plurality of positions further comprise a fifth position, a sixth position, a seventh position and an eighth position, the plurality of sections further comprise a fifth section corresponding to the fifth position, a sixth section corresponding to the sixth position, a seventh section corresponding to the seventh position and an eight section corresponding to the eighth position, the fifth section is distanced from the hub by 50 mm which is 22% of the span length and has a chord length of 27.9 mm, a pitch angle of 14-18 degree and a thickness of 3.5 mm, the sixth section is distanced from the hub by 125 mm which is 55% of the span length and has a chord length of 40.5 mm, a pitch angle of 11-15 degree and a thickness of 2 mm, the seventh section is distanced from the hub by 165 mm which is 85% of the span length and has a chord length of 35.9 mm, a pitch angle of 9-13 degree and a thickness of 2 mm, and the eighth section is distanced from the hub by 220 mm which is 96% of the span length and has a chord length of 20.7 mm, a pitch angle of 8-12 degree and a thickness of 1.5 mm.

20. The aerial vehicle according to claim 11, wherein the tailing edge has a wave shape, and the first position and the second position are wave peaks of the wave shape.
